(19) United States
(12) Patent Application Publication
(10) Pub. No.: US 2009/0167962 A1
(43) Pub. Date: Jul. 2, 2009

(54) Computer Monitors

(75) Inventors: Michael K. Goodman, Irvine, CA (US); Iain T. Learmonth, Hampshire (GB); Johnny Hsiang-yu Chen, Anaheim, CA (US)

Correspondence Address: GROOVER & Associates, BOX 802889, DALLAS, TX, 75380-2889, US

(73) Assignee: I/O Interconnect Inc., Santa Ana, CA (US)

(21) Appl. No.: 12/006,346

(22) Filed: Jan. 2, 2008

(51) Int. Cl. H04N 5/66

(52) U.S. Cl. 348/739; 348/E05.133

(57) ABSTRACT

A computer monitor has an input for receiving from a general-purpose computer a video signal representing a video image, a screen, and a driver for causing the screen to display a video image represented by a video signal. The monitor further includes storage for storing video and/or picture data, a processor for retrieving video and/or picture data from the storage means and producing a video signal therefrom, and a switch for switching the monitor between (i) a first “monitor” mode in which the driver causes the screen to display the video image represented by the signal received by the input and (ii) a second “media player” mode in which the driver causes the screen to display the video and/or picture image represented by the signal produced by the processor. This therefore provides the functionality of a media player in a computer monitor so that, when the monitor is not being used for displaying the video output from the general-purpose computer, it can be used instead as a media player, reducing number of the main pieces of equipment required, and enabling the general-purpose computer to be switched off and therefore to conserve energy when merely the media playing functions are required.

### BACKGROUND OF THE INVENTION

1. Field of the Invention

This invention relates to computer monitors and to systems of computers and computer monitors.

2. Description of the Related Art

Referring to FIG. 1 of the accompanying drawings, a typical computer monitor 10 comprises an input 12 (such as a cable or socket) for receiving from a general-purpose computer 14 a video signal representing a video image, a screen 16 (such as an LCD panel or a CRT), and driver circuits 18 for causing the screen 16 to display the video image represented by the signal received by the input 12. In many cases, a typical computer monitor 10 also includes (or is arranged for connection to) at least one loudspeaker 20, the input 22 is also arranged to receive an audio signal from the computer 14, and the driver circuits 18 are also arranged to cause the loudspeaker 20 to produce sound represented by the audio signal received by the input 22.

Personal computers were originally used predominantly for processing numbers and words. However, in recent years, personal computer have been used increasingly for viewing and/or listening to media data 24 (such as pictures, movies, movie clips, and audio) which have been downloaded from the internet, received with an email or transferred to the computer from the user's camera or a removable memory card. Indeed, the recently launched Vista operating system 26 includes extensive “Media Center” functionality whereby a computer can become a complete entertainment system. The Media Center functions can be controlled through a remote control 28 (see also FIG. 2), which can transmit remote control signals to a receiver 30 in the computer 14.

Media data can also be viewed and/or listened to using a dedicated media player 32, an example of which is also shown schematically in FIG. 1. A typical known media player 32 includes permanent storage 34 (such as a high capacity flash memory) for media data 36 and the operating system 38 of the media player 32, a reader 40 for removable memory 42 such as a flash card, a processor 44, a screen 46 (such as an LCD panel) and one or more loudspeakers 48. The media player 32 can be controlled by a push-button panel 50 and/or by a remote control 52 (see also FIG. 3) which can transmit remote control signals to a receiver 54 in the media player 32 so as to play the media data 36. The media player 32 may also have a data port 56 (such as a USB port) which can communicate with a complementary data port 58 of a general-purpose computer 14 so that media data can be transferred between the storage 60 of the computer 14 and the storage 34 of the media player 32.

Newer operating systems such as Vista are making use of the increasing availability of multi-media sources and presenting them through tools such as ‘Sideshow’. Sideshow is a function that enables a general-purpose computer to drive a variety of media players 32 and other auxiliary display devices with their own processors, enabling access to information and media through the media player 32 even when the computer 14 is turned off. The media player 32 can be updated using Sideshow with a wide range of multi-media data, such as video, music, contacts, maps, calendar appointments, and email messages. The media player 32 can then provide access to data and multimedia content even though the general-purpose computer 14 is turned off.

While the multi-media capabilities of a general-purpose desktop computer 14 are nowadays extensive, desktop computers 14 are not energy efficient compared with a dedicated media player 32, especially when off-line content is played. In order to obtain the benefits of a general-purpose desktop computer 14 and a dedicated media player 32, it is necessary, with the current state of the art, for a user to possess a media player 32, a desktop computer 14 and a monitor 10 for the computer 14, i.e. three main pieces of equipment.

### BRIEF SUMMARY OF THE INVENTION

In accordance with a first aspect of the present invention, there is provided a computer monitor comprising input means for receiving from a computer a video signal representing a video image, a screen, and driver means for causing the screen to display a video image represented by a video signal, the monitor further including storage means for storing video and/or picture data, retrieval means for retrieving video and/or picture data from the storage means and producing a video signal therefrom, and switching means for switching the monitor between (i) a first mode in which the driver means causes the screen to display the video image represented by the signal received by the input means and (ii) a second mode in which the driver means causes the screen to display the video and/or picture image represented by the signal produced by the retrieval means. The first aspect of the invention therefore provides the functionality of a media player in a computer monitor so that, when the monitor is not being used for displaying the video output from a general-purpose computer, it can be used instead as a media player, reducing the number of main pieces of equipment required from three to two, and enabling the general-purpose computer to be switched off and therefore to conserve energy when merely the media playing functions are required.

The switching means is preferably arranged to be controlled automatically in dependence upon a signal produced or received by the monitor. For example, the switching means is more preferably arranged to be controlled automatically in dependence upon whether or not a video signal is being received by the input means such that, when such a video signal is being received by the input means, the first mode is selected. In other words, the monitor can act to display the video output from the computer when a video signal is being received, but at other times acts as a media player, without requiring any specific intervention by the user to change the mode of operation.

In accordance with second aspect of the invention, there is provided a computer monitor of the first aspect of the invention, in combination with a computer having means for generating a video signal for supply to the input means of the monitor.

The computer and monitor may be provided in further combination with a remote control arranged to produce and transmit remote control signals in dependence upon operation of the remote control by a user; the computer monitor having means to receive such transmitted remote control signals, means to decode such received remote control signals, and means for affecting operation of the monitor in dependence upon such decoded remote control signals; the computer having means to receive such transmitted remote control signals, means to decode such received remote control signals, and means for affecting operation of the computer in dependence upon such decoded remote control signals; wherein at least some operations of the remote control by the user have similar effects on the computer and on the monitor. For example, a single Vista Media Centre remote control may be used not only to control the Media Centre functionality of the computer when the computer is active, but also to control the media player functionality of the monitor when the computer is inactive, in each case causing the computer or the monitor to respond appropriately to a command from the remote control. There is therefore no need for two separate remote controls.

The computer monitor preferably further includes means for connecting the monitor to the computer for communication of data between the monitor and the computer, and in this case the monitor is preferably arranged, when in the first mode, to present the storage means of the monitor to the computer as a removable storage device accessible by the computer. For example, when the computer is active, the computer may play media files in the storage means of the monitor as if they were stored in the storage means of the computer, and media files may simply be copied or moved between the storage means of the computer and of the monitor.

In the case where the computer monitor including controls arranged to be manually operable by a user, at least some of the controls are preferably arranged to affect the monitor in different manners in dependence upon the mode in which the monitor is. For example, user-operable buttons on the monitor may be used not only to adjust brightness, contrast, etc when in the first mode, but also to start and stop the play of media files when in the second mode, without requiring a corresponding increase in the number of buttons required.

At least the screen, driver means, retrieval means and switching means of the computer monitor are preferably housed in a common housing.

In accordance with a third aspect of the invention, there is provided a computer monitor of the first aspect of the invention in combination with a loudspeaker, wherein: (i) the input means is also arranged to receive an audio signal from the computer, (ii) the storage means is also arranged to store audio data, (iii) the retrieval means is also arranged to retrieve audio data from the storage means and produce an audio signal therefrom, (iv) the driver means is also arranged to cause the loudspeaker to produce sound represented by an audio signal, (v) when in the first mode the driver means causes the loudspeaker to produce the sound represented by the audio signal received by the input means, and (vi) when in the second mode the driver means causes the loudspeaker to produce the sound represented by the audio signal produced by the retrieval means. The monitor therefore deals with the switching between audio signals in a similar manner to the switching between video signals.

In accordance with a fourth aspect of the invention, there is provided a system comprising a computer, a computer monitor and a remote control; the computer having means for generating a video signal representing a video image; the monitor comprising input means for receiving the video signal from the computer; storage means for storing video and/or picture data; and a housing which houses a screen, a driver means, a retrieval means and a switching means; the retrieval means being arranged to retrieve video and/or picture data from the storage means and produce a video signal therefrom; the switching means being arranged to switch the monitor automatically in dependence upon a signal produced or received by the monitor between (i) a first mode in which the driver means causes the screen to display the video image represented by the signal received by the input means and (ii) a second mode in which the driver means causes the screen to display the video and/or picture image represented by the signal produced by the retrieval means; the remote control being arranged to produce and transmit remote control signals in dependence upon operation of the remote control by a user; the computer monitor having means to receive such transmitted remote control signals, means to decode such received remote control signals, and means for affecting operation of the monitor in dependence upon such decoded remote control signals; the computer having means to receive such transmitted remote control signals, means to decode such received remote control signals, and means for affecting operation of the computer in dependence upon such decoded remote control signals; and wherein at least some operations of the remote control by the user have similar effects on the computer and on the monitor.

### BRIEF DESCRIPTION OF THE SEVERAL VIEWS OF THE DRAWINGS

FIG. 1 is a schematic diagram of a known system comprising a computer, a monitor and a first remote control for the computer, a media player and a remote control for the media player.

FIG. 2 is a schematic plan view, on a larger scale, of the first known remote control that may be used with the computer of FIG. 1.

FIG. 3 is a schematic plan view, on the larger scale, of the second known remote control that may be used with media player of FIG. 1.

FIG. 4 is a schematic diagram of a system comprising a computer, a media-playing monitor for the computer and in accordance with an embodiment of the invention, and a remote control for the computer and the monitor.

FIG. 5 is a state diagram to illustrating modes of operation of the media-playing monitor.

### DETAILED DESCRIPTION OF PREFERRED EMBODIMENTS OF THE INVENTION

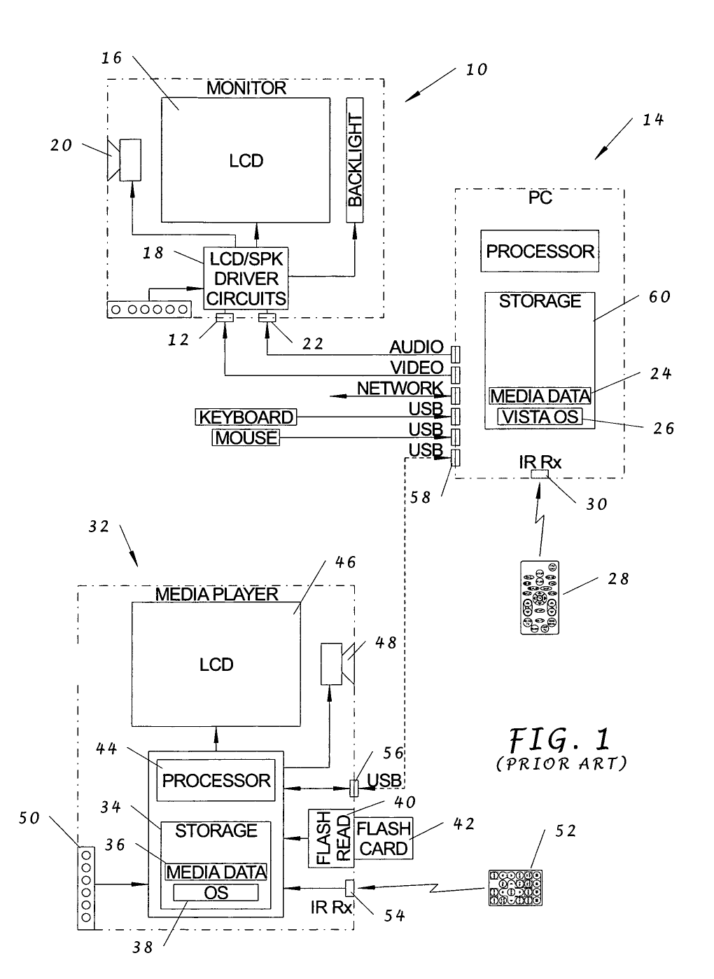

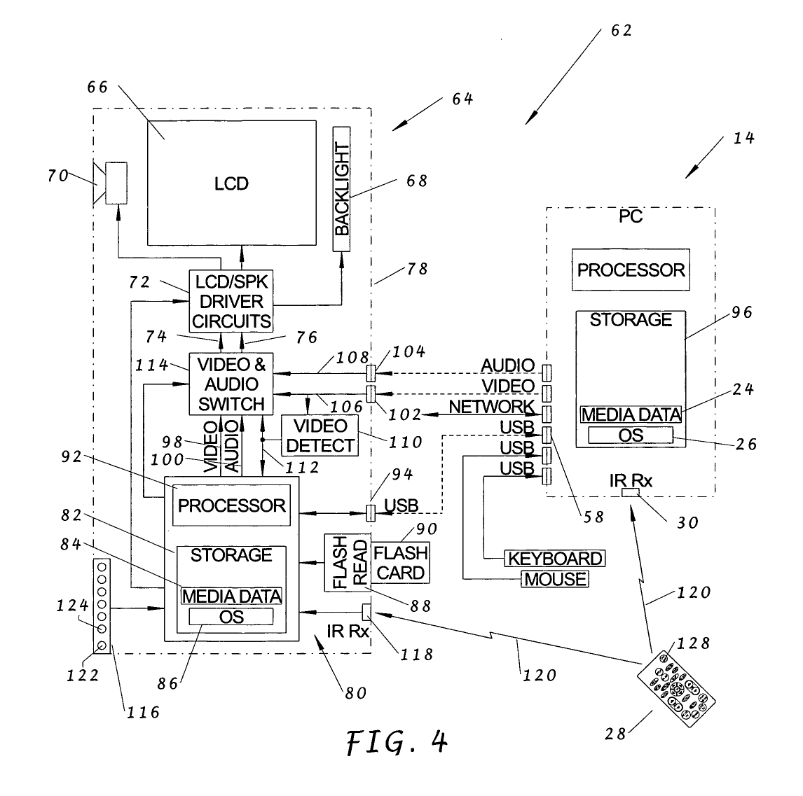

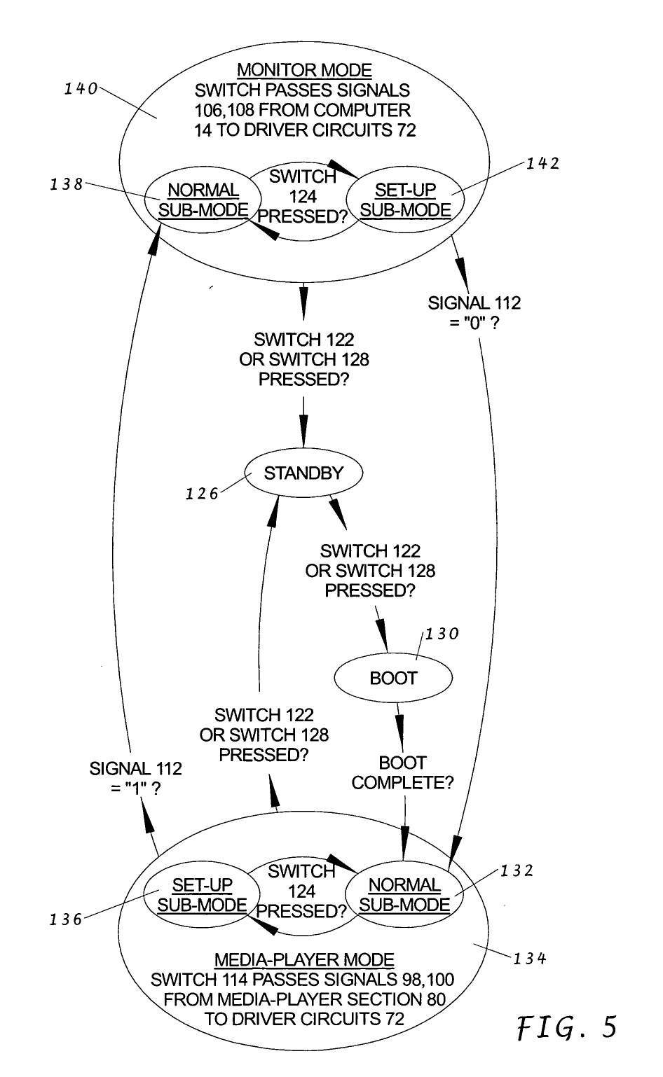

Referring to FIG. 4 of the drawings, a computer system 62 includes a personal computer 14, which may be identical to the computer 14 described above with reference to FIG. 1, and a media-playing monitor 64. The computer may, for example, employ the Vista operating system.

Similarly to a conventional monitor 10 described above with reference to FIG. 1, the monitor 64 includes, within a housing 78, an LCD panel 66 with a backlight 68, one or more loudspeakers 70, and driver circuits 72 for driving the LCD panel 66 and loudspeaker 70 in accordance with received video and audio signals 74,76.

Unlike a conventional monitor, the housing 78 of the media-playing monitor 64 also includes a media-player section 80 comprising: permanent storage 82 (such as a high capacity flash memory) which stores media data files 84 and an operating system 86 of the media player section 80; a reader 88 for removable memory 90 such as a flash card; a processor 92; and a USB data port 94 which can communicate with a complementary data port 58 of a computer 14 so that media data can be transferred between the storage 96 of the computer 14 and the storage 82 of the media-playing monitor 64. When playing a media data file 84, the processor 92 causes video and/or audio signals 98,100 to be output from the media-player section 80.

The media-playing monitor 64 also has input ports 102,104 for receiving video and audio signals 106,108 from the computer 14, and a detection circuit 110 which determines when such a video signal 106 is being received and supplies a 1-bit signal 112 to the media-player section 80 and also to a switch 114 as a control signal. The detection circuit 110 may operate in any convenient way, for example by detecting the presence of the clock signal or a synchronisation signal in the case of VGA video. The detection circuit 110 and switch 114 are arranged so that, when a video signal 106 is being received from the computer 14, the video and audio signals 106,108 from the computer 14 are passed on as the video and audio signals 74,76, respectively, to the driver circuits 72, this being a “monitor mode” of the media-playing monitor 64, whereas when a video signal 106 is not being received from the computer 14, the video and audio signals 98,100 from the computer 14 are passed on as the video and audio signals 74,76, respectively, to the driver circuits 72, this being a “media-playing mode” of the media-playing monitor 64.

The media-playing monitor 64 has a control panel 116 with a number of push-button switches, including a standby switch 122 and a set-up switch 124 to which the processor 92 can respond. The processor 92 is arranged to respond differently to some of the switches of the control panel 116 in dependence upon the mode, as shown in the Table A:—

TABLE A

| Switch | | Switch | | | | | | |
|---|---|---|---|---|---|---|---|---|
| “1” | Mode | “2” | | Switch | Switch | Switch | Switch | Switch |
| 122 | (automatic) | 124 | | “3” | “4” | “5” | “6” | “7” |
| Toggle | Monitor | Toggle | Normal | nil | nil | (Increase | (Decrease | (Toggle |
| between | | between | sub- | | | volume) | volume) | mute |
| “standby” | | monitor | mode | | | | | on and |
| and “on” | | normal | | | | | | off) |
| | | and set- | Set-up | Previous | Next | Increase | Decrease | Select |
| | | up sub- | sub- | monitor | monitor | monitor | monitor | setting |
| | | modes | mode | setting | setting | setting | setting | |
| | Media- | Toggle | Normal | Stop | Play | Increase | Decrease | Toggle |
| | playing | between | sub- | media | media | volume | volume | mute |
| | | media- | mode | | | | | on and |
| | | playing | | | | | | off |
| | | normal | Set-up | Previous | Next | Increase | Decrease | Select |
| | | and set- | sub- | media- | media- | media- | media- | setting |
| | | up sub- | mode | player | player | player | player | |
| | | modes | | setting | setting | setting | setting | |

As can be seen, in any mode, operation of switch “1” 122 toggles the media-playing monitor 64 between a “standby” state and an “on” state. When in the monitor mode, operation of switch “2” 124 toggles between a monitor set-up sub-mode and a normal monitor sub-mode. When in the normal monitor sub-mode, the remaining switches “3” to “7” may be inoperative, or some of the switches may be used to control the audio output from the loudspeaker 70. However, when in the monitor set-up sub-mode, an on-screen display (“OSD”) is provided on the LCD panel 66 and the OSD set-up functionality of a conventional computer monitor is provided by the switches “3” to “7” for adjusting settings such as the brightness, contrast, focus and colour of the display on the LCD panel 66. By contrast, when in the media player mode, operation of switch “2” 124 toggles between a media-player set-up sub-mode and a normal media-player sub-mode. When in the normal media-player sub-mode, the remaining switches “3” to “7” are operable to provide basic control over the media-player, for example to stop and start playback of a media file and to control the audio output from the loudspeaker 70. However, when in the media-player set-up sub-mode, an on-screen display is provided on the LCD panel 66 and OSD set-up functionality is provided by the switches “3” to “7” for adjusting settings of the media-player section 80.

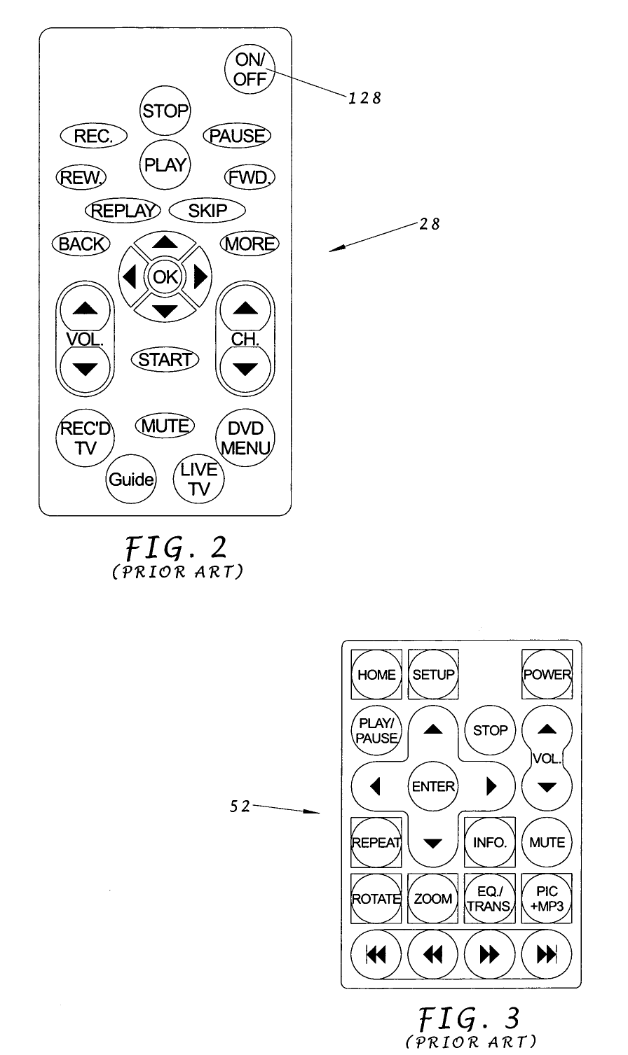

The media-playing monitor 64 also has an infra-red remote control receiver 118 which can receive remote control signals 120 from a remote control 28, and the processor 92 is arranged to respond to the received signals, but only when the signal 112 from the video detection circuit 110 indicates that a video signal 106 is not being received from the computer 14. The same remote control 28 is used for controlling the computer 14 and the media-playing monitor 64. In the case where the computer 14 employs the Vista operating system, the remote control 28 is preferably a conventional Windows Media Center remote control such as the Compact Media Center Edition remote control 28 as shown in FIG. 2, so that, when the computer 14 is switched on, the remote control 28 can control the computer 14 in the conventional manner. Such a remote control 28 uses remote control codes defined by the Philips RC-6 infrared remote control protocol. The media player section 80 of the monitor 64 may be based on the ESS DMP chip, e.g. part no. ES6425 available from ESS Technology, Inc, CA 94538, USA, which conventionally uses a different remote control code protocol and is normally arranged to be controlled by the remote control 52 shown in FIG. 3. The media-player section 80 is therefore arranged to interpret the received remote control signals 120 from the remote control 28 differently from normal so that, where possible, there is similarity between the action taken by the computer 14, when it is active, in response to a particular command from the remote control 28 and the action taken by the media-player section 80, when the computer 14 is inactive, in response to the same command from the remote control 28. An example of a mapping between buttons of the remote control 28 and the action taken by the media-player section 80 is shown in the Table B:—

TABLE B

| MCE compact | Media Player | |
|---|---|---|
| remote button | response | Notes |
| Up | Up | Identical response |
| Down | Down | |
| Left | Left | |
| Right | Right | |
| Power | Power | |
| Stop | Stop | |
| Mute | Mute | |
| REW | REW | |
| FWD | FWD | |
| Skip | Skip | |
| Replay | Replay | |
| Volume Up | Volume Up | |
| Volume Down | Volume Down | |
| OK (Select) | Enter | |
| Start | Home | Related response |
| Play | Play/Pause | |
| Pause | Play/Pause | |
| More | Info | |
| Guide | Equaliser | Unrelated response |
| Ch+ | Zoom | |
| Ch− | Rotate | |
| Back (Exit) | Repeat (loop) | |
| Record | | No response in media playing mode |
| Recorded TV | | |
| Live TV | | |
| DVD Menu | | |
| | Setup | Provided by control panel 116 |
| | Pic + MP3 | Function not provided in media |
| | | playing mode |

It will be noted that the majority of the buttons on the remote control 28 are operable to cause identical responses from the Media Center running on the computer 14 when the computer 14 is operating (and the monitor 64 is therefore automatically in its monitor mode) to the responses from the media-player section 80 of the monitor 64 when the computer 14 is not operating (and the monitor 64 is therefore automatically in its media-playing mode). It should also be noted that the remote control 28 controls the computer 14 when it is active, and the media-player section 80 when the computer 14 is inactive, without the user needing to select on the remote control 28 which piece of equipment is to be controlled.

When the monitor 64 is in the media-player mode, the media-player section 80 can play the media data files 84 that are stored in the permanent flash storage 82 and in any flash card 90 that may be inserted into the flash reader 88. On the other hand, when the monitor 64 is in the monitor mode, the media-player section 80 communicates with the computer 14 via the USB ports 94,58 not only so that the media-player section 80 appears to the computer 14 as a conventional auxiliary display device through the Sideshow functionality of Vista, but also so that the permanent flash storage 82 of the monitor 64 appears as a removable drive of the computer 14, and any inserted flash card 90 appears as a further removable drive of the computer 14. The user of the computer 14 therefore has access to the media files 84 of the monitor 80 so that they can be played, copied, moved and deleted.

The various modes of the media-playing monitor 64 are shown in the state diagram of FIG. 5. Starting from the standby state 126, the monitor 64 waits for the standby switch 122 to be pressed on the control panel 116 or the power switch 128 to be pressed on the remote control 28, whereupon the monitor 64 enters a boot state 130. Once booting is complete, the monitor 64 enters the normal sub-mode 132 of the media-player mode 134. If the set-up switch 124 is then pressed on the control panel 116, the monitor 64 changes to the set-up sub-mode 136 of the media-player mode 134, and if the set-up switch 124 is then pressed again on the control panel 116, the monitor 64 reverts to the normal sub-mode 132 of the media-player mode 134. While in the media-player mode 134, the level of the signal 112 from the detection circuit 110 is repeatedly checked, and if it becomes logic “1” indicating that the monitor 64 is receiving a video signal 106 from computer 14, the monitor 64 changes to the normal sub-mode 138 of the monitor mode 140. If the set-up switch 124 is then pressed on the control panel 116, the monitor 64 changes to the set-up sub-mode 142 of the monitor mode 140, and if the set-up switch 124 is then pressed again on the control panel 116, the monitor 64 reverts to the normal sub-mode 138 of the monitor mode 140. While in the monitor mode 140, the level of the signal 112 from the detection circuit 110 is repeatedly checked, and if it becomes logic “0” indicating that the monitor 64 is no longer receiving a video signal 106 from computer 14, the monitor 64 reverts to the normal sub-mode 132 of the media-player mode 134. Whether in the media-player mode 134 or monitor mode 140, if the standby switch 122 is pressed on the control panel 116 or the power switch 128 is pressed on the remote control 28, the monitor 64 reverts to the standby state 126.

It will be appreciated that many modifications and developments may be made to the embodiment of the invention described above. For example, in the case where the USB port 58 of the computer 14 provides power when the computer 14 is active but no power when the computer 14 is inactive, the video detection circuit 110 may be replaced by a circuit which detects whether or not power is being received by the USB port 94 and signals the media-player section 80 and switch 114 accordingly. Alternatively, in the case where the audio signal 108 from the computer always contains hum when the computer 14 is active but not when the computer 14 is inactive, the video detection circuit 110 may be replaced by a circuit which detects whether or not hum is being received by the audio port 104 and signals the media-player section 80 and switch 114 accordingly.

It should be noted that the embodiment of the invention has been described above purely by way of example and that many modifications and developments may be made thereto within the scope of the present invention.

In the following claims, the reference numerals are not intended to limit the scope of the claims.

1. A computer monitor (64) comprising input means (102) for receiving from a computer a video signal (106) representing a video image, a screen (66), and driver means (72) for causing the screen to display a video image represented by a video signal (74), the monitor further including storage means (82) for storing video and/or picture data (84), retrieval means (92) for retrieving video and/or picture data from the storage means and producing a video signal (98) therefrom, and switching means (114) for switching the monitor between (i) a first mode (140) in which the driver means causes the screen to display the video image represented by the signal received by the input means and (ii) a second mode (134) in which the driver means causes the screen to display the video and/or picture image represented by the signal produced by the retrieval means.

2. A computer monitor as claimed in claim 1, wherein the switching means is arranged to be controlled automatically in dependence upon a signal (106) produced or received by the monitor.

3. A computer monitor as claimed in claim 2, wherein the switching means is arranged to be controlled automatically in dependence upon whether or not a video signal (106) is being received by the input means such that, when such a video signal is being received by the input means, the first mode is selected.

4. A computer monitor as claimed in claim 1, in combination with a computer (14) having means for generating a video signal for supply to the input means of the monitor.

5. A combination as claimed in claim 4, in further combination with a remote control (28) arranged to produce and transmit remote control signals (120) in dependence upon operation of the remote control by a user; the computer monitor having means (118) to receive such transmitted remote control signals, means (92) to decode such received remote control signals, and means (92) for affecting operation of the monitor in dependence upon such decoded remote control signals; the computer having means (30) to receive such transmitted remote control signals, means to decode such received remote control signals, and means for affecting operation of the computer in dependence upon such decoded remote control signals; wherein at least some operations of the remote control by the user have similar effects on the computer and on the monitor.

6. A computer monitor as claimed in claim 1, further including means (94) for connecting the monitor to the computer for communication of data between the monitor and the computer, and wherein the monitor is arranged, when in the first mode, to present the storage means of the monitor to the computer as a removable storage device accessible by the computer.

7. A computer monitor as claimed in claim 1, further including controls (116) arranged to be manually operable by a user, at least some of the controls being arranged to affect the monitor in different manners in dependence upon the mode in which the monitor is.

8. A computer monitor as claimed in claim 1, wherein the screen, driver means, retrieval means and switching means are housed in a common housing (78).

9. A computer monitor as claimed in claim 1 in combination with a loudspeaker (70), wherein: the input means (104) is also arranged to receive an audio signal (108) from the computer; the storage means is also arranged to store audio data, the retrieval means is also arranged to retrieve audio data from the storage means and produce an audio signal (100) therefrom; the driver means is also arranged to cause the loudspeaker to produce sound represented by an audio signal (76); when in the first mode the driver means causes the loudspeaker to produce the sound represented by the audio signal received by the input means; and when in the second mode the driver means causes the loudspeaker to produce the sound represented by the audio signal produced by the retrieval means.

10. A system (62) comprising a computer (14), a computer monitor (64) and a remote control (28); the computer having means for generating a video signal (106) representing a video image; the monitor comprising input means (102) for receiving the video signal from the computer; storage means (82) for storing video and/or picture data (84); and a housing (78) which houses a screen (66), a driver means (72), a retrieval means (92) and a switching means (114); the retrieval means being arranged to retrieve video and/or picture data from the storage means and produce a video signal (98) therefrom; the switching means being arranged to switch the monitor automatically in dependence upon a signal (106) produced or received by the monitor between (i) a first mode (140) in which the driver means causes the screen to display the video image represented by the signal received by the input means and (ii) a second mode (134) in which the driver means causes the screen to display the video and/or picture image represented by the signal produced by the retrieval means; the remote control being arranged to produce and transmit remote control signals (120) in dependence upon operation of the remote control by a user; the computer monitor having means (118) to receive such transmitted remote control signals, means (92) to decode such received remote control signals, and means (92) for affecting operation of the monitor in dependence upon such decoded remote control signals; the computer having means (30) to receive such transmitted remote control signals, means to decode such received remote control signals, and means for affecting operation of the computer in dependence upon such decoded remote control signals; and wherein at least some operations of the remote control by the user have similar effects on the computer and on the monitor.
